(19) United States
(12) Patent Application Publication
(10) Pub. No.: US 2007/0140162 A1
(43) Pub. Date: Jun. 21, 2007

(54) Apparatus and method for transmission on a fractional dedicated physical channel

(76) Inventor: Carolyn Taylor, Chicago Heights, IL (US)

Correspondence Address: MOTOROLA INC, 600 NORTH US HIGHWAY 45, ROOM AS437, LIBERTYVILLE, IL, 60048-5343, US

(21) Appl. No.: 11/312,297

(22) Filed: Dec. 20, 2005

(51) Int. Cl. H04Q 7/00

(52) U.S. Cl. 370/329

(57) ABSTRACT

A method and apparatus for transmission on a fractional dedicated physical channel. The fractional dedicated physical channel is divided into a plurality of frames. Each frame of the plurality of frames has a plurality of slots. A slot of the plurality of slots can include at least one field. A power setting indicator is transmitted in the field. The power setting indicator indicates an accuracy of a signal interference estimation.

### BACKGROUND

1. Field

The present disclosure is directed to a method and apparatus for transmission on a fractional dedicated physical channel. More particularly, the present disclosure is directed to transmission on a fractional dedicated physical channel using a plurality of frames where each frame has a plurality of slots.

2. Description of Related Art

Presently, users of mobile communication devices, such as cellular phones, on a wireless network can use high speed data packet access (HSDPA) on dedicated physical channels to send and receive data. HSDPA can provide for voice calls along with fast data rates for data applications. There are specific requirements for the setup of the dedicated physical channels for uplink and downlink connections for users using high speed data packet access. For example, a single channel is dedicated to a single user.

Unfortunately, with a potential increase of data-only applications, such as streaming applications, interactive applications, and background applications using low to medium bit rates, the cost of the dedicated channel may restrict a wider use of high speed data packet access. Allowing the flexibility to share dedicated code channels associated between data-only users can give the opportunity for a wider use of the high speed data packet access system because this reduces the single channel per user limitation problem. Unfortunately, there is no clear proposal on the power control scheme for a fractional dedicated physical channel including the definition of a proper slot structure. Thus, there is a need for a method and apparatus for transmission on a fractional dedicated physical channel

### SUMMARY

A method and apparatus for transmission on a fractional dedicated physical channel. The fractional dedicated physical channel is divided into a plurality of frames. Each frame of the plurality of frames has a plurality of slots. A slot of the plurality of slots can include at least one field. A power setting indicator is transmitted in the field. The power setting indicator indicates an accuracy of a signal interference estimation.

### BRIEF DESCRIPTION OF THE DRAWINGS

The embodiments of the present disclosure will be described with reference to the following figures, wherein like numerals designate like elements, and wherein:

FIG. 1 is an exemplary block diagram of a system according to one embodiment;

FIG. 2 is an exemplary illustration of a frame according to one embodiment;

FIG. 3 is an exemplary block diagram of a mobile communication device according to one embodiment;

FIG. 4 is an exemplary flowchart illustrating the operation of a network controller according to one embodiment; and

FIG. 5 is an exemplary flowchart illustrating the operation of a mobile communication device according to another embodiment.

### DETAILED DESCRIPTION

In this document, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

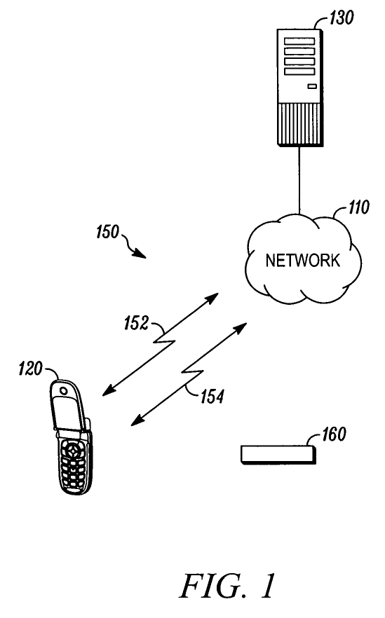

FIG. 1 is an exemplary block diagram of a system 100 according to one embodiment. The system 100 can include a network controller 130, a network 110, and a terminal 120. The terminal 120 may be a wireless communication device, such as a wireless telephone, a cellular telephone, a personal digital assistant, a pager, a personal computer, a selective call receiver, or any other device that is capable of sending and receiving communication signals on a network including wireless network.

In an exemplary embodiment, the network controller 130 is connected to the network 110. The network controller 130 may be located at a base station, at a radio network controller, or anywhere else on the network 110. The network 110 may include any type of network that is capable of sending and receiving signals, such as wireless signals. For example, the network 110 may include a wireless telecommunications network, a cellular telephone network, a Time Division Multiple Access (TDMA) network, a Code Division Multiple Access (CDMA) network, a satellite communications network, and other like communications systems. Furthermore, the network 110 may include more than one network and may include a plurality of different types of networks. Thus, the network 110 may include a plurality of data networks, a plurality of telecommunications networks, a combination of data and telecommunications networks and other like communication systems capable of sending and receiving communication signals.

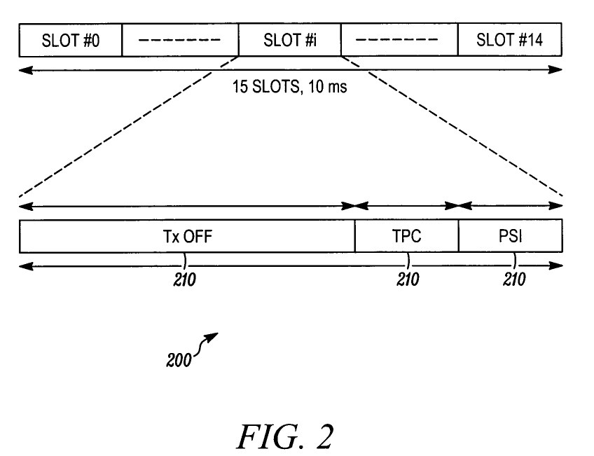

FIG. 2 is an exemplary illustration of a slot 200, such as a slot 160, according to one embodiment. The slot 200 can occupy one of 15 slots on a 10 ms dedicated physical channel frame 210 on a dedicated physical channel 150. The slot 200 can include a power setting indicator field 220, a transmit power control field 230, and a period 240 during which there is no transmission. The power setting indicator field 220 can be in a last field in the slot 200 and the transmit power control field 230 can be in a second last field in the slot 200. The power setting indicator field 220 may be one bit and the transmit power control field 230 may be one bit.

In operation, the terminal 120 can send and receive signals to and from the network 110 on a dedicated physical channel 150. The dedicated physical channel 150 can include a traffic channel 152 and a control channel 154. For example, the network controller 130 can transmit a plurality of frames including a plurality of slots on the dedicated physical control channel 154. The frame 210 is an example of one of the plurality of frames. The slot 200 structure can be made without pilot bits and with a power setting indicator 220 that indicates whether a power setting on the terminal 120 should remain fixed or be changed. This can allow the uplink power control to be affected by allowing the terminal 120 to increase the time available to decode the transmit power control 230 command and change an uplink transmit power. The downlink power control may not be affected because the amount of time may remain unchanged for the terminal 120 to measure the downlink signal to interference ratio and derive a transmit power control command to transmit in the uplink. The power setting indicator 220 can support a power setting in a fractionated physical channel. This power setting indicator 220 can be used to determine if a signal to interference ratio estimation is accurate or not. If the estimation is accurate then the terminal 120 can use a fixed power. For example, the terminal 120 can use the same type of power setting as a primary common pilot channel. If the signal to interference ratio estimation is deemed not accurate, then the terminal 120 can reconfigure a transmit power setting. Thus, for example, this flexible slot structure that can include a power setting indicator and may not include pilot bits can improve the efficiency of power setting for a fractional dedicated physical channel as well as reduce dedicated channel code overhead.

Therefore, the uplink dedicated channel of several terminals using the same downlink channel can be controlled. The slot structure can support, for example, power control with a one slot delay. The power setting indicator can be used in the slot structure to determine if a signal to interference estimation is accurate or not.

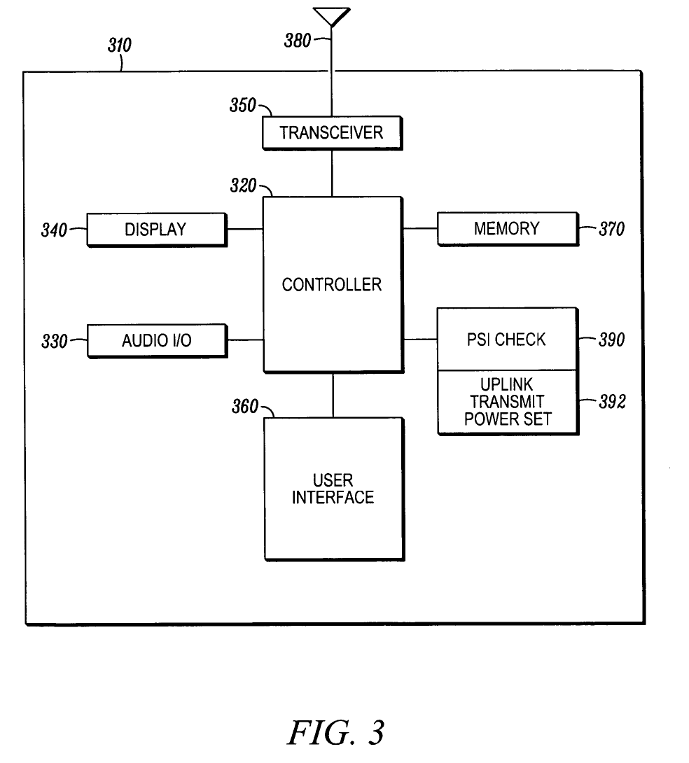

FIG. 3 is an exemplary block diagram of a wireless communication device 300, such as the terminal 120, according to one embodiment. The wireless communication device 300 can include a housing 310, a controller 320 coupled to the housing 310, audio input and output circuitry 330 coupled to the housing 310, a display 340 coupled to the housing 310, a transceiver 350 coupled to the housing 310, a user interface 360 coupled to the housing 310, a memory 370 coupled to the housing 310, and an antenna 380 coupled to the housing 310 and the transceiver 350. The wireless communication device 300 can also include a power setting indicator check module 390 and an uplink transmit power set module 392. The power setting indicator check module 390 and the uplink transmit power set module 392 can be coupled to the controller 320, can reside within the controller 320, can reside within the memory 370, can be autonomous modules, can be software, can be hardware, or can be in any other format useful for a module on a wireless communication device 300.

The display 340 can be a liquid crystal display (LCD), a light emitting diode (LED) display, a plasma display, or any other means for displaying information. The transceiver 350 may include a transmitter and/or a receiver. The audio input and output circuitry 330 can include a microphone, a speaker, a transducer, or any other audio input and output circuitry. The user interface 360 can include a keypad, buttons, a touch pad, a joystick, an additional display, or any other device useful for providing an interface between a user and an electronic device. The memory 370 may include a random access memory, a read only memory, an optical memory, a subscriber identity module memory, or any other memory that can be coupled to a mobile communication device.

In operation, the controller 320 can control the operations of the wireless communication device 300. A receiver in the transceiver 350 can receive a fractional dedicated physical channel frame. The fractional dedicated physical channel frame can include a plurality of slots. Each slot of the plurality of slots can include at least one field. The at least one field can include a power setting indicator. The power setting indicator check module 390 can check the power setting indicator. The uplink transmit power set module 392 can set an uplink transmit power based on the power setting indicator. For example, the uplink transmit power set module 392 can set an uplink transmit power by maintaining a fixed uplink transmit power if the power setting indicator indicates a signal interference ratio estimation is accurate. The uplink transmit power set module can also set an uplink transmit power by reconfiguring the uplink transmit power of the transceiver if the power setting indicator indicates a signal interference ratio estimation is inaccurate. The fractional dedicated physical channel frame can be a 10 millisecond frame including 15 slots. The fractional dedicated physical channel frame can include a transmit power control command in a second last field of the at least one field in a slot in the fractional dedicated physical channel frame. The power setting indicator can be received in a last field of a sequence of at least one field in a slot of one frame of the plurality of frames.

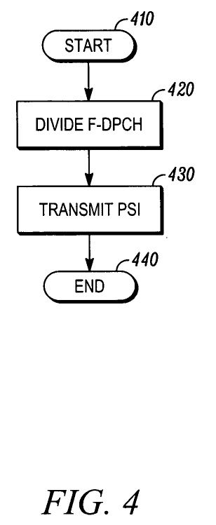

FIG. 4 is an exemplary flowchart 400 illustrating the operation of the network controller 130 according to another embodiment. For example, the flowchart 400 can illustrate a transmission method on a fractional dedicated physical channel. In step 410, the flowchart 400 begins. In step 420, the network controller 130 can divide the fractional dedicated physical channel 150 into a plurality of frames. Each frame of the plurality of frames can include a plurality of slots. Each slot can include at least one field. In step 430, the network controller 130 can transmit a power setting indicator in one of the at least one field. When transmitting the power setting indicator, the network controller 130 can also transmit a transmit power control command in a second last field of a sequence of fields in a slot of a frame of the plurality of frames. The power setting indicator can indicate an accuracy of a signal interference estimation. Each frame of the plurality of frames can be a 10 millisecond frame. Also, each frame of the plurality of frames further can have 15 slots. The power setting indicator can be transmitted in a last field of the at least one field in a slot in a frame of the plurality of frames. The power setting indicator can indicate an uplink transmit power setting is to remain fixed if the signal interference estimation is accurate. The power setting indicator can also indicate an uplink transmit power setting should be reconfigured if the signal interference estimation is inaccurate. The fractional dedicated physical channel can be a fractional dedicated physical control channel. In step 440, the flowchart 400 can end.

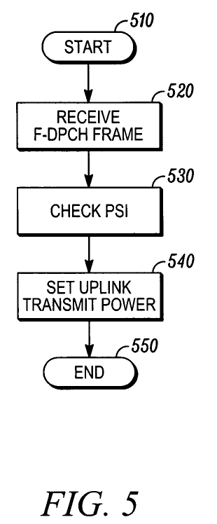

FIG. 5 is an exemplary flowchart 500 illustrating the operation of the wireless communication device 300 according to one embodiment. For example, the flowchart 500 can illustrate the operation of a wireless device using a fractional dedicated physical channel. In step 510, the flowchart 500 begins. In step 520, the wireless communication device 300 can receive a fractional dedicated physical channel frame. The fractional dedicated physical channel frame can include a plurality of slots. At least one slot can include at least one field. The at least one field can include a power setting indicator. In step 530, the wireless communication device 300 can check the power setting indicator. In step 540, the wireless communication device 300 can set an uplink transmit power based on the power setting indicator. The wireless communication device 300 can set an uplink transmit power by maintaining a fixed uplink transmit power if the power setting indicator indicates a signal interference ratio estimation is accurate. The wireless communication device 300 can also set an uplink transmit power by reconfiguring the uplink transmit power if the power setting indicator indicates a signal interference ratio estimation is inaccurate. The fractional dedicated physical channel frame can be a 10 millisecond frame including 15 slots. The fractional dedicated physical channel frame can include a transmit power control command in a second last field in a slot in the fractional dedicated physical channel frame. The power setting indicator can be received in a last field in a slot in a frame of the plurality of frames. In step 550, the flowchart 500 can end.

The method of this disclosure is preferably implemented on a programmed processor. However, the controllers, flowcharts, and modules may also be implemented on a general purpose or special purpose computer, a programmed microprocessor or microcontroller and peripheral integrated circuit elements, an ASIC or other integrated circuit, a hardware electronic or logic circuit such as a discrete element circuit, a programmable logic device such as a PLD, PLA, FPGA or PAL, or the like. In general, any device on which resides a finite state machine capable of implementing the flowcharts shown in the Figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, the preferred embodiments of the disclosure as set forth herein are intended to be illustrative, not limiting. Various changes may be made without departing from the spirit and scope of the disclosure.

What is claimed is:

1. A transmission method on a fractional dedicated physical channel, the method comprising:
dividing the fractional dedicated physical channel into a plurality of frames, each frame of the plurality of frames including a plurality of slots, each slot including at least one field; and
transmitting a power setting indicator in one of the at least one field, the power setting indicator indicating an accuracy of a signal interference estimation.

2. The transmission method according to claim 1, wherein each frame of the plurality of frames comprises a 10 millisecond frame.

3. The transmission method according to claim 1, wherein each frame of the plurality of frames further comprises 15 slots.

4. The transmission method according to claim 1, wherein the power setting indicator is transmitted in a last field of a slot.

5. The transmission method according to claim 1, further comprising transmitting a transmit power control command in a second last field of a slot.

6. The transmission method according to claim 1, wherein the power setting indicator indicates an uplink transmit power setting is to remain fixed if the signal interference estimation is accurate.

7. The transmission method according to claim 1, wherein the power setting indicator indicates an uplink transmit power setting should be reconfigured if the signal interference estimation is inaccurate.

8. The transmission method according to claim 1 wherein the fractional dedicated physical channel comprises a fractional dedicated physical control channel.

9. A method of operating a wireless device using a fractional dedicated physical channel, the method comprising:
receiving a fractional dedicated physical channel frame, the fractional dedicated physical channel frame including a plurality of slots, each slot including at least one field, one of the at least one field including a power setting indicator;
checking the power setting indicator; and
setting an uplink transmit power based on the power setting indicator.

10. The method according to claim 9, wherein setting an uplink transmit power comprises maintaining a fixed uplink transmit power if the power setting indicator indicates a signal interference ratio estimation is accurate.

11. The method according to claim 9, wherein setting an uplink transmit power comprises reconfiguring the uplink transmit power if the power setting indicator indicates a signal interference ratio estimation is inaccurate.

12. The method according to claim 9, wherein the fractional dedicated physical channel frame comprises a 10 millisecond frame including 15 slots.

13. The method according to claim 9, wherein the fractional dedicated physical channel frame further includes a transmit power control command in a second last field of a slot in the fractional dedicated physical channel frame.

14. The method according to claim 9, wherein the power setting indicator is received in a last field of a slot.

15. A wireless device comprising:
a controller configured to control the operations of the wireless device;
a receiver coupled to the controller, the receiver configured to receive a fractional dedicated physical channel frame, the fractional dedicated physical channel frame including a plurality of slots, at least one slot can include at least one field including a power setting indicator;
a power setting indicator check module coupled to the controller, the power setting indicator check module configured to check the power setting indicator; and
an uplink transmit power set module coupled to the controller, the uplink transmit power set module configured to set an uplink transmit power based on the power setting indicator.

16. The wireless device according to claim 15, wherein the uplink transmit power set module is further configured to set an uplink transmit power by maintaining a fixed uplink transmit power if the power setting indicator indicates a signal interference ratio estimation is accurate.

17. The wireless device according to claim 15, wherein the uplink transmit power set module is further configured to set an uplink transmit power by reconfiguring the uplink transmit power if the power setting indicator indicates a signal interference ratio estimation is inaccurate.

18. The wireless device according to claim 15, wherein the fractional dedicated physical channel frame comprises a 10 millisecond frame including 15 slots.

19. The wireless device according to claim 15, wherein the fractional dedicated physical channel frame further includes a transmit power control command in a second last field in a slot in the fractional dedicated physical channel frame.

20. The wireless device according to claim 15, wherein the power setting indicator is received in a last field in a slot in a frame of the plurality of frames.
